(19) United States
(12) Patent Application Publication
(10) Pub. No.: US 2005/0183035 A1
(43) Pub. Date: Aug. 18, 2005

(54) Conflict resolution for graphic multi-user interface

(76) Inventors: Meredith J. Ringel, Stanford, CA (US); Kathleen Ryall, Cambridge, MA (US); Chia Shen, Lexington, MA (US); Clifton Lloyd Forlines, Cambridge, MA (US); Frederic Vernier, Paris (FR)

Correspondence Address: Patent Department;Mitsubishi Electric Research Laboratories, Inc., 201 Broadway, Cambridge, MA, 02139, US

(21) Appl. No.: 10/717,829

(22) Filed: Nov. 20, 2003

(51) Int. Cl. G06F 3/00; G09G 5/00

(52) U.S. Cl. 715/811; 345/156; 345/173; 715/747; 715/745; 715/789; 715/810

(57) ABSTRACT

A graphic multi-user interface resolves multi-user conflicts. The interface includes a touch sensitive surface on which items, such as documents and images, can be displayed. The items have an associated state and policy. Touch samples are generated when users touch the touch sensitive surface. Each samples is identified with a particular user generating the of sample. The samples are associated with particular items. Touching items generates events. A decision with respect to a conflict affecting a next state of a particular item is made according to the events, the state and the policy.

### FIELD OF THE INVENTION

The present invention relates generally to graphic user interfaces, and more particularly to user interfaces that allow multiple users to provide simultaneously conflicting input.

### BACKGROUND OF THE INVENTION

A typical graphic user interface (GUI) for a computer implemented application includes an input device for controlling the applications, and an output device for showing the results produced by the application after acting on the input. The most common user interface includes a touch sensitive device, e.g., a keyboard, a mouse or a touch pad for input, and a display screen for output.

It is also common to integrate the input and output devices so it appears to the user that touching displayed items controls the operation of the underlying application, e.g., an automated teller machine for a banking application.

Up to now, user interfaces have mainly been designed for single users. This has the distinct advantage that there is no problem in determining who is in control of the application at any one time.

Recently, multi-user user touch devices have become available, see Dietz et al., “DiamondTouch: A multi-user touch technology,” Proc. User Interface Software and Technology (UIST) 2001, pp. 219-226, 2001, and U.S. Pat. No. 6,498,590 “Multi-user touch surface,” issued to Dietz et al., on Dec. 24, 2002, incorporated herein by reference. A general application framework for that touch surface is described in U.S. Published patent application 20020101418 “Circular Graphical User Interfaces,” filed by Vernier et al., published on Aug. 1, 2002, incorporated herein by reference.

That touch surface can be made arbitrarily large, e.g., the size of a tabletop. In addition, it is possible to project computer-generated images on the surface during operation. As a special feature, that device is able to distinguish unequivocally multiple simultaneous touches by multiple users, and even multiple touches by individual users.

As long as different users are pointing at different displayed items this is usually not a problem. The application can easily determine the operations to be performed for each user using traditional techniques. However, interesting new difficulties arise when multiple users indicate conflicting operations for the same item. For example, one user attempts to drag a displayed document to the left, while another user attempts to drag the same document to the right. Up to now, user interfaces have not had to deal with conflicting commands from multiple simultaneous users manipulating displayed items.

In order to take full advantage of a multi-user interface, as described above, there is a need for a system and method that can resolve such conflicts.

Enabling multiple users to simultaneously operate an application gives rise to several types of conflicts. For instance, one user could “grab” an electronic document while another user is interacting with that document. Alternatively, one user attempts to alter an application setting that adversely impacts activities of other users.

Typically prior art solutions use ownership levels and access privileges to ‘resolve’ conflicts. However, such techniques either require explicit directions to resolve conflicts, or alternatively, apply arbitrary and inflexible rules that may not reflect a dynamic and highly interactive situation, as are now possible with graphic multi-user interfaces.

Scott et al., in “System Guidelines for Co-located, Collaborative Work on a Tabletop Display,” Proc. ECSCW, pp. 159-178, 2003, summarize major design issues facing the emerging area of tabletop collaborative systems. They cite policies for accessing shared digital objects as a key concern. Steward et al. in “Single Display Groupware: A Model for Co-present Collaboration,” Proc. CHI 1999, pp. 286-293, 1999, warn of potential drawbacks of single display groupware technologies. They state “new conflicts and frustrations may arise between users when they attempt simultaneous incompatible actions.”

Prior art work on conflict-resolution and avoidance in multi-user applications has focused on software that enables remote collaboration, and is concerned mainly with preventing inconsistent states that can arise due to network latencies. For example, Greenberg et al., in “Real Time Groupware as a Distributed System: Concurrency Control and its Effect on the Interface,” Proc. CSCW 1994, pp. 207-217, 1994 are concerned with the issue of concurrency control in distributed groupware, and provided a framework for locking data. They provide networking protocols to avoid inconsistent states that may arise because of time delays when users at remote sites issued conflicting actions.

Edwards et al., in “Designing and Implementing Asynchronous Collaborative Applications with Bayou,” Proc. UIST 1997, pp. 119-128, 1997 describe an infrastructure that supports conflict detection and resolution policies for asynchronous collaboration using merge procedures and dependency checks. Edwards et al. in “Timewarp: Techniques for Autonomous Collaboration,” Proc. CHI 1997, pp. 218-225, 1997 describe how to maintain separate histories for each object in an application, and provided facilities for resolving conflicting timelines. Edwards, in “Flexible Conflict Detection and Management In Collaborative Applications,” Proc. UIST 1997, pp. 139-148, 1997, describes a conflict-management infrastructure that provides general capabilities to detect and manage conflicts, and applications built on top of this infrastructure to decide what conflicts need to handle and how. However, all of the above conflicts are due to inconsistencies caused by delays in remote collaboration applications. Edwards, in “Policies and Roles in Collaborative Applications,” Proc. CSCW 1996, pp. 11-20, 1996, describes how policies can be specified in terms of access control rights. Again, most prior art systems rely generally on explicit access permissions.

Another class of techniques rely on “social protocols.” However, merely relying on social protocols to prevent or resolve conflicts is not sufficient in many situations. In some cases, social protocols provide sufficient mediation in groupware. However, social protocols cannot prevent many classes of conflicts including conflicts caused by accident or confusion, conflicts caused by unanticipated side effects of a user's action, and conflicts caused by interruptions or deliberate power struggles, see Greenberg et al. above.

Smith et al., in “Supporting Flexible Roles in a Shared Space,” Proc. CSCW 1998, pp. 197-206, 1998, state that social protocols are sufficient for access control, but then observe that problems often arose from unintentional user actions. As a result, they revise their system to include privileges for certain classes of users.

Izadi et al., in “Dynamo: A Public Interactive Surface Supporting the Cooperative Sharing and Exchange of Media,” Proc. UIST 2003, describe a system that relies largely on social protocols for handling conflicts. They observe that users have problems with ‘overlaps’, i.e., situations where one user's interactions interfered with interactions of another user.

Therefore, there is a need for a graphic multi-user interface that can resolve conflicting actions initiated simultaneously by multiple users operating on a single device having both input and output capabilities.

### SUMMARY OF THE INVENTION

A graphic multi-user interface resolves multi-user conflicts. The interface includes a touch sensitive surface on which items, such as documents and images, can be displayed.

The items have an associated state and policy. Touch samples are generated when users touch the touch sensitive surface. Each samples is identified with a particular user generating the of sample.

The samples are associated with particular items. Touching items generate events.

A decision with respect to a conflict affecting a next state of a particular item is made according to the events, the state and the policy.

### BRIEF DESCRIPTION OF THE DRAWINGS

FIG. 1 is a block diagram of a system and method according to the invention;

FIG. 2 is a chart of policies used by the system and method of FIG. 1;

FIG. 3 is a top view of a touch sensitive surface of the system of FIG. 1;

FIG. 4 is a block diagram of a display surface partitioned into work areas; and

FIG. 5 is a block diagram of a tearing action.

### DETAILED DESCRIPTION OF THE PREFERRED EMBODIMENT

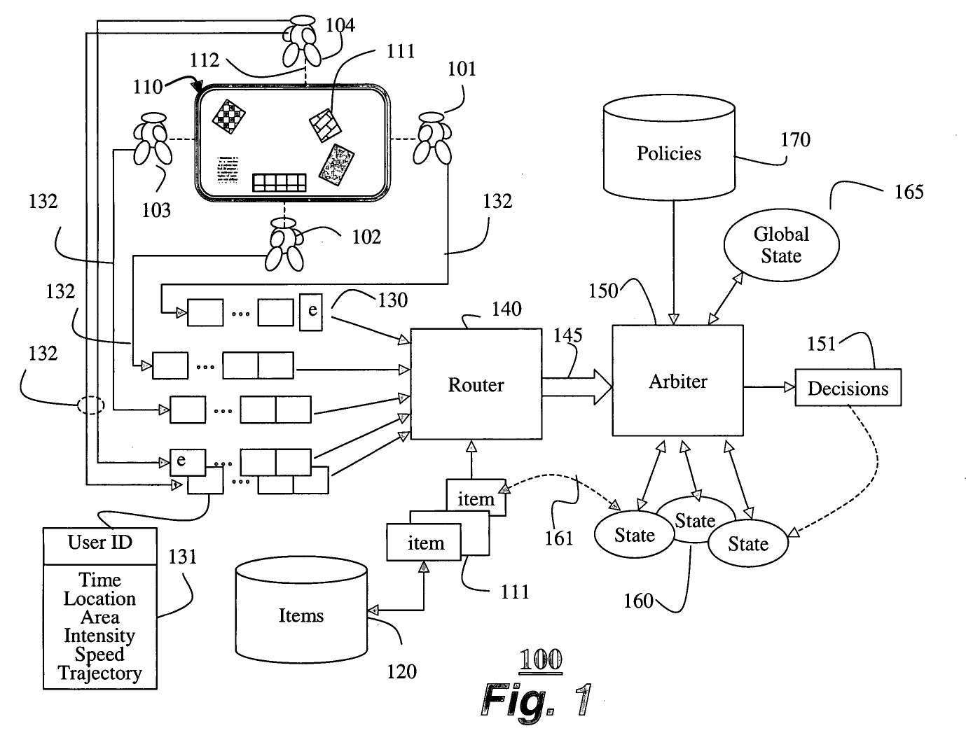

FIG. 1 shows a graphic multi-user interface system and method 100 according to the invention. The system includes a single touch sensitive display surface 110 in the form of a top of a table. It should be noted that the touch surface can be implemented using any known technologies. Items 111 are displayed on the surface using an overhead or rear projector. The items can include images, documents, icons, control buttons, menus, videos, pop-up messages, and the like. Thus, the single interface has both input and output capabilities. Multiple users 101-104 placed around the interface 110 can simultaneously touch the surface 110 to operate an application.

The displayed items 111, are maintained in a database 120. In addition to the underlying multimedia content, the displayed items have a number of associated parameters that define, in part, a state 160 of the item. The state can change over time, e.g., owner, access code, size, orientation, color and display location. A user can activate an item by touching the item, or by a menu selection. When the item is active the user can change the parameters by touching the item, for example, relocating or resizing the item with a fingertip, as described below.

The multiple users 101-104 are situated around the interface. The items 111 are displayed according to touches made by the users. When a particular user touches the surface at a particular location, capacitive coupling 112 between the user and the surface generates a touch sample(s) 130. The coupling 112 enables a unique identification (ID) between each user and each touch sample, even when multiple users simultaneously generate multiple touch samples. The touch surface is sampled at a regular rate and as long as users are touching the surface, the samples are generated as sequences 132. It should be noted that a single user can generate multiple sequences of samples, as shown for user 104. In this case, the user has multiple linked identities.

Each touch sample 130 for a particular user ID includes the following information 131: user ID, time, location, area, and signal intensity. Because individual touch sensitive elements embedded in the surface are relatively small when compared to the size of a finger tip, the touch samples have a two-dimensional ‘area’. Thus, the touch samples according to the invention are distinguished from zero-dimensional touch locations used in the prior art touch devices. The location can be the centroid of the area of touch. Because capacitive coupling is used, pressure and conductivity at the finger tip can alter the signal intensity. For a sequence of samples 132 for a particular user ID, the time and location can be used to ‘track” a moving touch according to a speed and a trajectory of the moving touch. All of the information that is part of a touch sample can be used to resolve conflicting touches as described in greater detail below.

Touch samples are fed to a router 140. The router associates the touch samples with displayed items. If a sample ‘touches’ an item, the sample is considered an event.

It should be noted that multiple touch events from multiple users can be associated with one displayed item at a particular time. For example, two users are both trying to ‘drag’ an item to opposite sides of the table. Competing simultaneous touch events generate conflicts. It is an object of the invention to resolve such conflicts.

Therefore, the touch events for each user with their associated items that include states are fed 145 to an arbiter 150. The arbiter makes a decision 151. The decision determines how conflicts are resolved, how touch events are converted into a next operation of the system, and how the touched item should be displayed in response to the conflicting touching. The decision is based on a current state 160 associated 161 with an item and policies 170 associated with the item and user(s), and a global state 165. Policies can be assigned to items as described below, and form part of the state of items. Conventional processing and rendering procedures can be applied to the items after the decision 151 is made.

Conflict

The method according to the invention recognizes global, and element conflicts.

A global conflict affects an application as a whole. Examples include changing a current “virtual table” being viewed from round to square, issuing a command that changes a layout or arrangement of all items on the touch sensitive display surface, or attempting to stop the application. As all of these actions are potentially disruptive to other users, these operations are governed by global collaboration policies.

An element conflict involves a single displayed item. Examples include multiple users trying to access the same document, or multiple users trying to select different operations from the same menu.

The following sections describe how various conflicts are resolved by the graphic multi-user interface according to the invention.

Policy Relationships

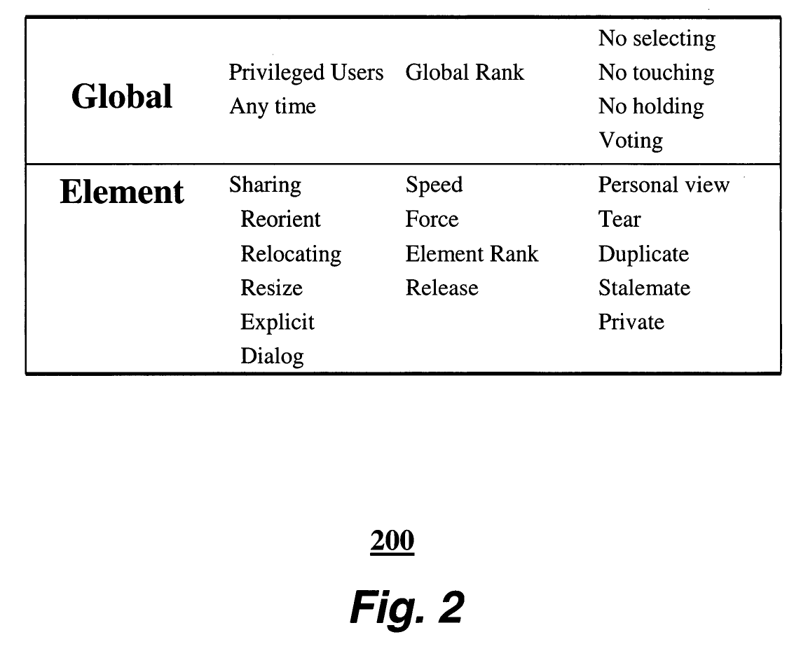

FIG. 2 shows how the policies relate with respect to conflict type. Policies can be associated with items using ‘pop-up’ menus. An item can have one or more policies associated with it. These are described in greater details.

Global Coordination Policies

Privileged User: With this policy, all global actions have a minimum associated privilege level. Users also have an associated privilege level. When a user initiates a global action, this policy checks to see if the user's privilege level is higher than the action's minimum privilege level. If false, then the action is ignored, otherwise, if true, then the action is performed.

Anytime: This is a permissive policy that permits global changes to proceed regardless of current states 160 of the items 111. This policy is included for completeness and to provide an option for applications that rely on social protocols.

Global Rank: With this policy, each user has an associated rank. This policy factors in differences in rank among users, and can be used in conjunction with other policies, such as “no holding documents.” Thus, using the rank policy means that a global change succeeds when the user who initiated the change has a higher rank than any users who are currently associated with active items

No Selections, No Touches, No Holding: These three policies dictate conditions under which a change to a global state succeeds when none of the users: have an “active” item, are currently touching the surface anywhere, or are “holding” items, i.e., touching an active item. If all three conditions are true a global state change can occur.

Voting: This policy makes group coordination more explicit by soliciting feedback from all active users in response to a proposed global change. Each user is presented with a displayed voting item, i.e., a ballot, which enables the users to vote for or against the change. Several voting schemes, e.g., majority rules, supermajority, unanimous vote, etc., are possible for determining the decision. The user identification can be used to enforce fair voting. Rank can also be considered during the voting.

Element Coordination Policies

Sharing: The sharing policy enables users to dynamically change the policy of an item by transitioning between the ‘public’ and ‘private’ policies. To support sharing, the following interactions are permitted: release, reorient, relocate, and resize.

Release: This technique mimics interactions with paper documents. If user 101 ‘holds’ an item by touching it and user 102 attempts to acquire the same item, then user 102 does not acquire the item as long as user 101 continues to hold the document. However, if user 101 ‘releases’ the touch from the item, then user 102 acquires the item.

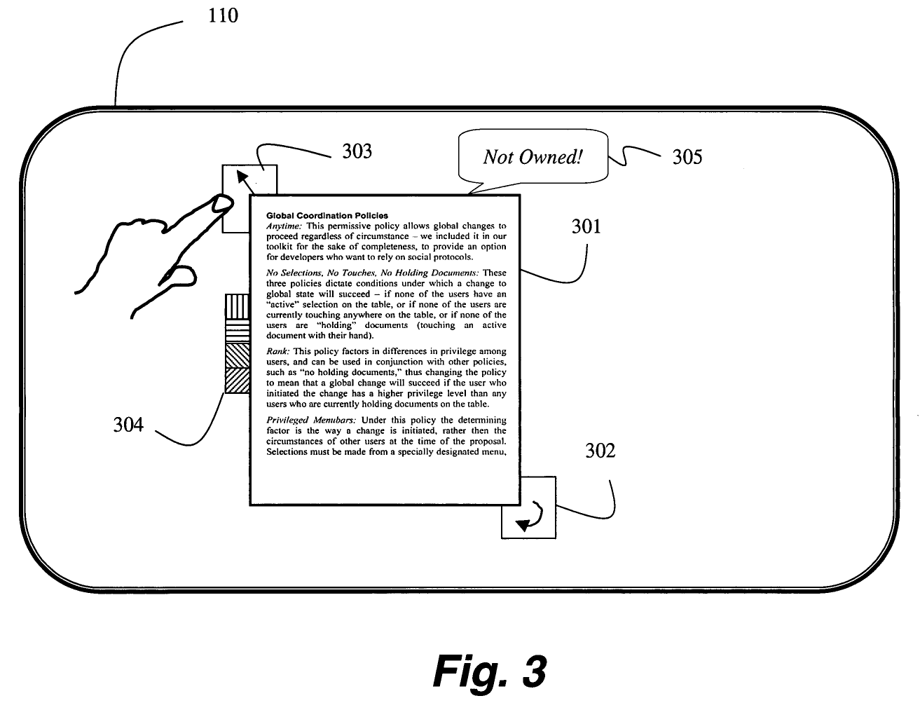

Reorient: The orientation of an item can be used to indicate whether the item is private, or public and shared. An item can be made public for sharing when the item is orienting towards the center of the display surface. The item is oriented towards a particular user to indicate privacy. As shown in FIG. 3, an item 301 can be reoriented by touching a displayed rotate tab 302 near a bottom corner of the item.

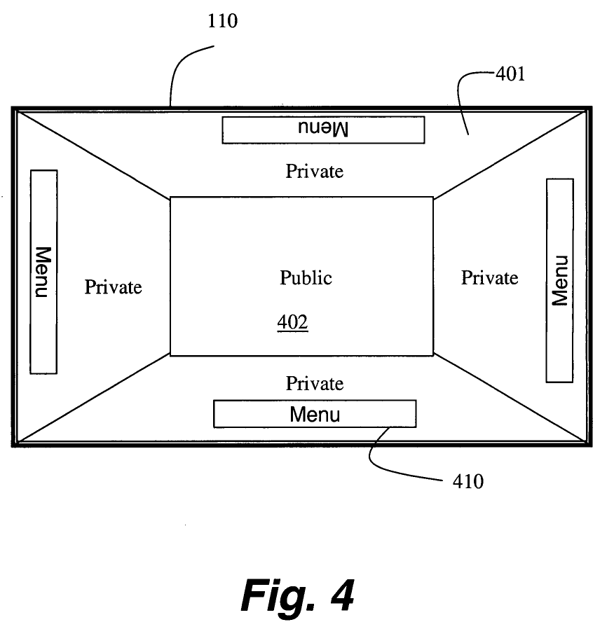

Relocating: As shown in FIG. 4, the display surface can be partitioned into private work areas 401 and public work areas 402, as described in U.S. patent application Ser. No. 10/613,683, “Multi-User Collaborative Graphical User Interfaces,” filed by Shen et al. on Jul. 3, 2003, incorporated herein by reference. The various work areas can be indicated by different coloring schemes. Work areas can have associated menus 410. Moving an item into a public work area makes the item public so that any user can operate on the item. Moving the item to a user's work area makes the item private. Access privileges can also be indicated for the work areas. Items are relocated by touching the item near the middle and moving the finger tip to a new location.

Resize: When an item is made smaller than a threshold size, the item becomes private, while enlarging the item makes the item available for shared public access. This association is based on the concept that larger displays tend to invite ‘snooping.’ The item is resized by touching a resize tab 303 displayed near a top corner of the item.

Explicit: With this policy, the owner of the item retains explicit control over which other users can access the item. As shown in FIG. 3, the owner can grant and revoke access permissions by touching colored tabs 304 displayed near an edge of the item. There is one colored tab for each of the users 101-104. The colors of the tabs can correspond to the colors of the user work areas. When a colored tab is touched, the transparency of the color can be changed to indicate a change in ownership. This way the colored tabs provide explicit access control with passive visual feedback. It should be noted that item ownership can be indicated by other means.

Dialog: This policy displays an explanatory message 305 when a decision is made.

Speed, Area and Force: These policies use a physical measurement to determine the decision. The measurement can be the speed at which a user is moving the item. Thus, fast fingers can better snatch items than slow fingers. Placing an open hand on an item trumps a mere finger tip. The amount of force that is applied by pressure of the finger increases the signal intensity of the event. Heavy handed gestures can win decisions. A sweaty finger might also increase the signal intensity, thus sticky fingers can purloin contested documents.

Element Rank: This policy makes the decision in favor of the user with the highest associated rank. For example, if two or more users try to move a document simultaneously, the document moves according to the actions of the user with the highest rank. In this way, a user with a higher rank can “steal” documents from users with lower ranks.

Personal view: This policy enables a user to acquire an item from another user or to select from another user's menu. The item is adapted for the acquiring user. For example, if a menu for user 101 has a list of bookmarks made by user 101, then the menu is adapted to show the bookmarks of user 102. The user 101 bookmarks are not displayed. If user 101 has annotated an item, then those annotations are not be revealed to user 102 upon acquisition of the item.

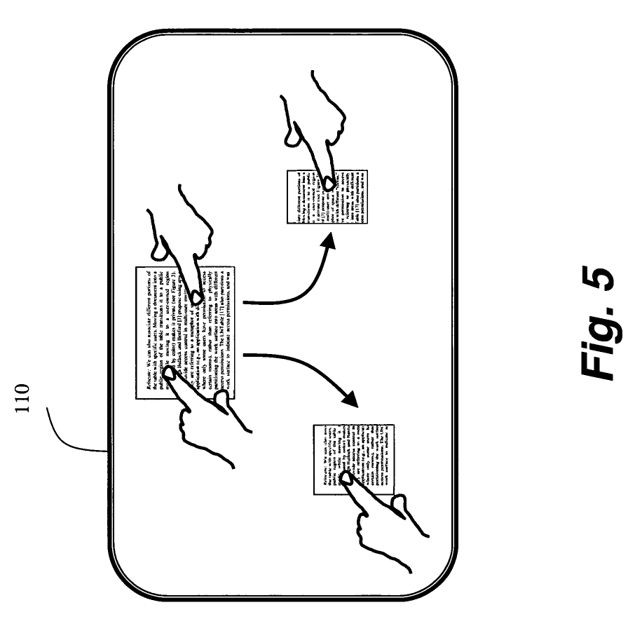

Tear: As shown in FIG. 5, this policy ‘tears’ an item into parts when multiple users attempt to acquire the item simultaneously. This policy is inspired by interactions with paper. This strategy handles a conflict between two users over a single document by breaking the document into two pieces.

Duplicate: One way to avoid conflict over a particular item is to create a duplicate of the original item. Under this policy, the contested item is duplicated. Duplication can be effected in the following manners. (1) The duplicate item is ‘linked’ to the original item so that a change in either item is reflected in the other item. (2) The duplicate item is a read-only copy. (3) The duplicate item is a read-write copy fully independent of the original item.

Stalemate: Under this policy, “nobody wins.” If user 101 is holding an item and user 102 attempts to take it, not only is user 102 unsuccessful, but user 101 also loses control of the item.

Private: This policy is the most restrictive. Only the owner of an item can operate on the item.

Public: This policy is least restrictive without any policies in effect.

Applications

The policies described herein can be used individually or in combination, depending on the context of the application. For example, in an application to support group meetings, the policies can affect both collaborative and individual work. In an educational setting, the “rank” policy can distinguish teachers and students. Policies such as speed, area, and force lend themselves to gaming applications, while the “duplicate” or “personalized views” policies are useful in a ‘design’ meeting where each team member desires to illustrate a different variation of a proposed design.

### EFFECT OF THE INVENTION

The invention provides policies for a graphic multi-user interface that allows users to initiate conflicting actions simultaneously. Such policies provide predictable outcomes to conflicts that arise in multi-user applications. Although prior art social protocols may be sufficient to prevent such problems in simple situations, more deterministic options become necessary as the number of users, the number of items, and the size of the interactive surface increase.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

1. A graphic multi-user interface for resolving conflicts, comprising:
a touch sensitive surface;
means for displaying a plurality of items on the touch sensitive surface;
means for generating a plurality of sequences of touch samples when a plurality of users simultaneously touch the touch sensitive surface, each sequence of samples being identified with a particular user generating the sequence of samples;
means for associating each sequence of samples with a particular item, the particular item having an associated state and a policy;
generating an event for each associated sequence of samples; and
means for determining a decision with respect to a conflict affecting a next state of the particular item according to the events from the plurality of users, the state and the policy.

2. The graphic multi-user interface of claim 1, in which the state of the item includes an owner, an access code, a size, an orientation, a color and a display location.

3. The graphic multi-user interface of claim 1, in which the particular item is active when a particular user is touching the particular item.

4. The graphic multi-user interface of claim 1, in which one particular user generates multiple sequences of sample for multiple touches.

5. The graphic multi-user interface of claim 1, in which each sample includes a user ID, a time, a location, an area and a signal intensity of the touch.

6. The graphic multi-user interface of claim 5, in which each sample includes a speed and trajectory of the touch.

7. The graphic multi-user interface of claim 1, in which the policy is global when the conflicts affects an application as a whole.

8. The graphic multi-user interface of claim 1, in which the policy is element when the conflicts affects a particular item.

9. The graphic multi-user interface of claim 1, in which the policy is privileged user depending on privilege levels of the plurality of users.

10. The graphic multi-user interface of claim 1, in which each user has an associated rank and the decision is based on the ranks of the plurality of users.

11. The graphic multi-user interface of claim 1, in which the policy is based on a votes made by the plurality of users.

12. The graphic multi-user interface of claim 1, in which the policy is release, and the decision is based on a last user touching the particular item.

13. The graphic multi-user interface of claim 1, in which the decision is based on an orientation of the particular item.

14. The graphic multi-user interface of claim 1, in which the decision is based on a location of the particular item.

15. The graphic multi-user interface of claim 1, in which the decision is based on a size of the particular item.

16. The graphic multi-user interface of claim 1, further comprising:
means for displaying an explanatory message related to the decision.

17. The graphic multi-user interface of claim 1, in which the decision is based on a speed of the events.

18. The graphic multi-user interface of claim 1, in which the decision is based on an area of the events.

19. The graphic multi-user interface of claim 1, in which the decision is based on a signal intensity of the events.

20. The graphic multi-user interface of claim 1, in which the decision tears the particular item into multiple parts.

21. The graphic multi-user interface of claim 1, in which the decision duplicates the particular item.

22. The graphic multi-user interface of claim 7, in which the application has a global state, and further comprising:
allowing a change to the global state only if all times are inactive, no users are touching the touch sensitive surface or any of the plurality of items.

23. A method for resolving conflicts with a graphic multi-user interface, comprising:
displaying a plurality of items on a touch sensitive surface;
generating a plurality of sequences of touch samples when a plurality of users simultaneously touch the touch sensitive surface, each sequence of samples being identified with a particular user generating the sequence of samples;
associating each sequence of samples with a particular item, the particular item having an associated state and a policy;
generating an event for each associated sequence of samples; and
determining a decision with respect to a conflict affecting a next state of the particular item according to the events from the plurality of users, the state and the policy.
